(19) United States
(12) Patent Application Publication
(10) Pub. No.: US 2014/0067435 A1
(43) Pub. Date: Mar. 6, 2014

(54) REVENUE DRIVEN SPLITTING OF GROUP TRAVEL REQUESTS INTO MULTIPLE SUBGROUPS

(71) Applicants: Sergiu Hasnas, Saint Laurent Du Var (FR); Rémi De La Crouee, Antibes (FR); Matthieu Bareges, Nice (FR); Joel Singer, Antibes (FR); Benjamin Cany, Antibes (FR)

(72) Inventors: Sergiu Hasnas, Saint Laurent Du Var (FR); Rémi De La Crouee, Antibes (FR); Matthieu Bareges, Nice (FR); Joel Singer, Antibes (FR); Benjamin Cany, Antibes (FR)

(73) Assignee: AMADEUS S.A.S., Sophia Antipolis Cedex (FR)

(21) Appl. No.: 13/598,809

(22) Filed: Aug. 30, 2012

(51) Int. Cl. G06Q 50/14; G06Q 10/02

(52) U.S. Cl. 705/5

(57) ABSTRACT

A method, apparatus and program product utilize a revenue driven approach to split a group travel request into multiple subgroups. By doing so, group travel requests that might otherwise be rejected due to lack of availability for a certain quantity of travelers, or that might otherwise present a significant risk of lost revenue due to last minute cancellations that preclude reallocation to individual bookings, may be split into multiple subgroups in a manner that optimizes expected revenue for a travel provider. In addition, a method, apparatus and program product integrate a group quote component or module into an inventory system to facilitate the generation of group quotes based at least in part on a displacement cost for a reference travel provider that is reflective of the displacement of a group quantity from individual bookings.

### FIELD OF THE INVENTION

The exemplary embodiments of this invention relate generally to revenue management for the travel and tourism industry and, more specifically, relate to computer-implemented inventory systems and revenue management systems used in the travel industry.

### BACKGROUND OF THE INVENTION

In order to optimize revenue, the airline industry faces a number of complex issues directed toward balancing the demand from customers and the supply in terms of the airlines' respective capacities for transporting passengers. Bookings of passengers on flights are typically made either on an individual basis, e.g., via individual bookings for individual passengers or small groups of passengers, or on a group basis, where reservations are made to accommodate a relatively large party of passengers, e.g., school groups, church groups, tour groups, etc. desiring travel to the same destination.

Group travel requests, in particular, may be an important part of the overall business of an airline, and appropriate group revenue management may represent an important revenue opportunity. Group travel requests are typically characterized by a lack of pre-defined, published fares, as for many group travel requests, the expected revenue/group quote is individually calculated for each group by airline group revenue management analysts. Group travel request originators typically send group travel requests to airline sales agents who then either calculate the price based on airline group revenue management analyst indications (e.g., price grids, adjustments, etc.) or based on a group quote directly calculated by airline group revenue management analysts.

In addition, group travel requests are typically initiated far in advance of the date(s) of travel (often 6-12 months in advance), and are often more price sensitive than schedule sensitive. In addition, cancellations often do not involve a penalty even if made close to departure.

Given these characteristics, group request originators tend to overestimate their needs, and furthermore, a reasonable likelihood exists that cancellations will occur prior to departure. Consequently, a risk exists that some of the inventory that was previously allocated to a group request, and that could otherwise have been sold and allocated to individual bookings, will go unused, and thus result in lost revenue for the travel provider.

Moreover, group travel requests can potentially require a significant portion of the overall flight capacity of an aircraft, and as a result, the overall impact on a flight in case of possible cancellations can be significant. For example, a cancellation of 50 travelers in a group travel request for 100 travelers travelling on an aircraft with a capacity of 200 would have a significant impact on the final load factor for the aircraft, and would present a significant loss of revenue for the airline.

Consequently, a significant need exists in the art for an improved manner of managing group travel requests to minimize adverse the impacts of cancellations and underutilization of inventory, and thereby maximize revenue.

Another issue associated with group travel requests is the difficulty associated with determining an appropriate quote for a group travel request. For individual bookings, the travel industry has developed sophisticated algorithms for calculating quotes based upon available and expected inventory and revenue data such as yields or bid-prices. However, these algorithms are often not well suited for generating quotes for group travel requests. Groups are a distinct market and the profitability of a group is more complex to determine than that of an individual traveler due to strategic concerns and relatively higher risk of cancellations. Airlines are also typically reluctant to publish group fares given that they are typically discounted relative to individual fares and are highly circumstance-specific. As a result, group travel request quotes are often determined manually and on a more ad-hoc basis, often eliminating the ability to use automation to maximize revenue.

Consequently, a significant need also exists in the art for an improved and more automated manner of generating quotes for group travel requests.

### SUMMARY OF THE INVENTION

The invention addresses these and other problems associated with the prior art by providing in one aspect a method, apparatus and program product that utilize a revenue driven approach for splitting a group travel request into multiple subgroups. By doing so, group travel requests that might otherwise be rejected due to lack of availability for a certain quantity of travelers, or that might otherwise present a significant risk of lost revenue due to last minute cancellations that preclude reallocation to individual bookings, may be split into multiple subgroups in a manner that optimizes expected revenue for a travel provider.

Consistent with one aspect of the invention, a group travel request for travel with a travel provider is processed by determining a set of travel solutions that match a group travel criterion for the group travel request and a travel provider criterion for the travel provider, where the group travel criterion includes a group quantity for the group travel request, splitting the group quantity into a plurality of subgroup quantities respectively allocated to travel solutions from the set of travel solutions to optimize expected revenue of the travel provider resulting from displacement of the group quantity from individual bookings.

The invention also addresses in another aspect a method, apparatus and program product that perform a group quote operation using a group quote component or module integrated into an inventory system and capable of utilizing a revenue driven approach for generating a group quote for a group travel request. The group quote operation is based at least in part on a displacement cost for a reference travel provider that is reflective of the displacement of a group quantity for the group travel request from individual bookings, and may be adjusted by an adjustment factor to address the particular business needs of the reference travel provider. Moreover, in some embodiments, interline agreements may be integrated into the group quote operation such that group quotes may be generated for segments in a travel solution that are subject to interline agreements, while group quotes may be generated for other segments associated with the reference travel provider based upon the concept of displacement cost.

Therefore, consistent with another aspect of the invention, a group travel request for a reference travel provider is processed by receiving a group travel request that identifies a group quantity and at least one segment, and, using program code resident in an inventory system for the reference travel provider, determining a group quote for the group travel request based upon a displacement cost, where the displacement cost is based upon displacement of the group quantity from individual bookings.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a computer system configured to implement a revenue driven group travel request split operation consistent with the invention.

FIG. 2 is a block diagram of an example implementation of a computer system capable of implementing the group travel request split system referenced in FIG. 1.

FIG. 3 is a flowchart illustrating an exemplary sequence of steps performed by a group split process when performing a revenue driven group travel request split operation in the system of FIG. 1.

FIG. 4 is a flowchart illustrating an exemplary sequence of steps performed by the split group travel request block referenced in FIG. 3.

FIG. 5 is a flowchart illustrating an exemplary sequence of steps performed by the redistribute quantities block referenced in FIG. 4.

FIG. 6 is a table showing two flights for use in illustrating the performance of a revenue driven group travel request split operation based on yield data using the process of FIG. 3.

FIG. 7 is a table illustrating the performance of a group travel request split operation based on yield data for the flights shown in FIG. 6.

FIG. 8 is a table showing three flights for use in illustrating the performance of a revenue driven group travel request split operation based on bid price data using the process of FIG. 3.

FIG. 9 shows the data of the table of FIG. 8 after having merged the three travel solutions according to a bid price order and displaced the seats of the group travel request using the process of FIG. 3.

FIG. 10 shows the data of the table of FIG. 9 after performing out-distribution using the process of FIG. 3.

FIG. 11 shows the data of the table of FIG. 9 after performing in-distribution using the process of FIG. 3.

FIG. 12 is a flowchart illustrating an exemplary sequence of steps in a group quote routine when performing a group quote operation in the system of FIG. 1.

### DETAILED DESCRIPTION

Embodiments consistent with the invention utilize in one aspect a revenue driven approach to split a group travel request into multiple subgroups. In particular, embodiments consistent with this aspect of the invention split a group quantity associated with a group travel request into a plurality of subgroup quantities respectively allocated to travel solutions from the set of travel solutions to optimize expected revenue of the travel provider resulting from displacement of the group quantity from individual bookings.

For the purpose of simplifying the discussion, the focus hereinafter will be on an implementation of the invention in connection with travel group requests for air travel, such that a travel provider is typically an airline or air carrier. It will be appreciated, however, that the invention may also be utilized in connection with other applications in the travel industry where group bookings or reservations may be desired, e.g., rail travel, ship travel, hotels, etc. Therefore, the invention is not limited to the particular air travel implementation discussed hereinafter.

As will be discussed in greater detail below, as group travel requests are received by airline sales agents, a group split revenue management oriented approach may be used to assist with increasing or otherwise optimizing airline revenue, e.g., by determining the travel solutions to be used and by calculating expected revenue for the group travel request split on these travel solutions so that subgroups may be steered towards flights with lower demand and thus lower expected revenue from individual bookings. In addition, airline capacity may be increased to accept large group travel requests by splitting them into subgroups instead of rejecting, as might otherwise occur if no flights are available to accommodate an entire group. The herein-described embodiments furthermore facilitate the automation of a group travel request split process to provide quick and reliable answers to group travel requests by agents and other potential group travel request originators.

Among other benefits, embodiments consistent with the invention may define split criteria in order to adapt a computation to airline group revenue management business needs, spread the risk of cancellations over several flights in case of non-materialization, allow for increased revenue by keeping higher revenue flights available for individual demand, while steering group travel requests towards lower demand flights, and avoid rejecting large group travel requests that would not fit into a single flight.

Certain terms used in the following description, and defined within the context of an air travel application of the invention, are defined as follows:

Group travel request: a request for a given origin and destination, cabin, possible travel dates etc. for a quantity of travelers, and typically above a threshold quantity for which there are no predefined fares, as may be the case, for example, for individual bookings. A special assessment from the revenue management department of the airline receiving the request is often needed in order to identify the travel solutions on which the quantity of travelers can be allocated and calculate the minimum revenue at which the group travel request can be accepted.

Group request originator: the initiator of a group travel request. The group request originator may be, for example, a travel agent, tour operator etc.

Airline sales agent: an airline agent, who receives group travel requests from request originators, enters them into the group split system and then based on the output received from the group split system builds an offer to the group request originator.

Airline group revenue management analyst: an airline agent responsible for the analysis of the revenue opportunity to accept group travel requests and the application of the airline revenue management policy when assessing possible travel solutions and group quotes.

Travel solution: an itinerary between an origin and destination determined by a travel solution building system. Travel solutions may be mono-segment or multi-segment belonging to distinct connecting flights (i.e., with distinct flight numbers). A multi-segment travel solution is therefore composed of a sequence of distinct segments.

Candidate travel solution: a travel solution that has been identified as a possible candidate for allocation of at least a portion of the quantity of travelers requested by a group travel request.

Inventory item: a unit or item from the saleable inventory on a travel solution, in some instances referred to as a seat, but typically not associated with any particular physical location on a travel solution (e.g., seat A17).

Subgroup: a set of inventory items that represents a part of the total quantity of inventory items requested by a group travel request and that is placed on a travel solution.

Group quantity: the number of travelers associated with a group travel request and for which a corresponding number of inventory items from an airline's inventory is desired.

Subgroup quantity: the number of inventory items allocated to a particular travel solution as a result of splitting a group travel request.

Segment: a leg or a group of consecutive legs from a boarding point to the off point on a given flight (i.e. same flight number). A segment may be mono leg or multi-leg.

Leg: the space between two consecutive scheduled stops on any given flight, i.e., a physical transfer of an aircraft from an airport to another.

Cabin/Travel cabin: a physical section of a transport apparatus (aircraft, train, bus, boat, etc.) such as First Class or Economy (Eco).

Booking Class: a marketing segmentation used for reservation control (typically related to expected revenue). Traditionally a booking class gathers bookings made for the same kind of product (e.g., 14 days advance purchase booking, non-refundable bookings, etc.), and is designated by a one letter code.

Revenue controls: controls retrieved or calculated from a revenue management system data feed such as yields, bid price, leg/cabin expected to board, materialization rate, etc.

Yield: a value typically defined for each booking class of a given travel solution. The yield is an estimation of how much revenue the carrier (e.g., airline) receives from a sale in the associated booking class and travel solution.

Bid price/bid price vector: a net value (bid price) for an incremental seat, spot or place (hereinafter, an inventory item) on a particular flight/leg/cabin in the airline network. The bid price is the marginal value of a given flight/cabin/leg, also referred to as minimum acceptable net revenue, hurdle price, shadow price or dual cost. The bid price is typically the minimum revenue at which an airline wishes to sell the inventory item, and is typically provided as a list of pairs <bid price value, item index> meaning that for selling the next remaining inventory item equal to the item index value, the minimum revenue of the bid price value is expected. The current item index corresponds to the number of remaining inventory items for a given leg and cabin at a given time.

Leg/cabin capacity: the total number or quantity of saleable inventory items in a cabin for a given leg. It includes the inventory items already sold.

Segment/cabin capacity: the minimum of the leg/cabin capacities of the legs included in the segment and for a given cabin.

Segment/cabin availability: the number or quantity of inventory items that can be sold on a segment and cabin at a given time.

Group segment/cabin availability: the number or quantity of inventory items that may be allocated to group travel requests on a given segment and cabin at a given time.

Group travel solution/cabin availability: the minimum between the group segment/cabin availabilities of the segments included in the travel solution and for the given cabin.

Travel solution/booking class availability: the number of inventory items that may be sold on a travel solution for a given booking class at a given time.

Leg/cabin expected load factor: the ratio between the leg/cabin expected to board counter and the leg/cabin capacity in percentage.

Segment/cabin expected load factor: the maximum of the leg/cabin expected load factors of the included leg cabins.

Leg/cabin expected to board counter: the number of expected occupied seats on the leg/cabin at departure time. This counter is retrieved from the revenue management system.

Segment/cabin group proportion: the ratio between the already existing group inventory items allocation and the capacity of a segment/cabin.

Group quote: also referred to herein as the expected revenue, and equal to the sum of the adjusted unitary displacement costs for a group or a subgroup on a cabin and the travel solutions where subgroups or the group has been placed. It corresponds to the minimum expected revenue for a group or subgroup expressed in a given currency.

Unitary displacement cost: the revenue or opportunity cost that the airline expects by accepting an individual booking for an inventory item on a travel solution and cabin instead of allocating it to a group travel request.

Adjusted unitary displacement cost: the unitary displacement cost adjusted by a factor.

Materialization rate: the ratio between the quantities allocated to group travel requests occupied at departure time and the group quantities that were requested initially in group travel requests. The materialization rate may be defined per travel agent or tour operator and aggregated at a regional level.

Market: an entity at airline level in the reference data component, which may be an association of regions/countries/cities/airports/offices. A market is usually defined to represent a specific part of the world, of a continent, of a country, an association of offices, etc.

Revenue management system: a computerized system that attempts to optimize revenues through continual monitoring of passenger demand, market trends and pricing activity, providing optimum inventory allocation. The revenue management system provides data such as yields, bid price, expected to board etc.

Inventory system: a computerized system that includes flight inventories with information on different capacities, reservations, availabilities etc. It also defines the cabins and booking classes.

Schedule system: a computerized system that includes flight schedules and builds travel solutions.

Group travel request split system: a computerized system that performs a group travel request split operation.

Business rules management system: a computerized system that stores business rules suitable for customizing the behavior of a group travel request split operation.

Group travel criterion: one or more parameters associated with a group travel request and used in the determination of a set of matching candidate travel solutions for a particular group travel request, e.g., route, origin, destination, departure/arrival dates/date ranges, quantity of travelers, schedule flexibility, route flexibility such as maximum number of connections or specific connecting airport, minimum subgroup quantity, travel cabin, group type, etc.

Travel provider criterion: one or more parameters associated with a travel provider and used in the determination of a set of matching candidate travel solutions for a particular group travel request, e.g., minimum/maximum cabin group proportions, minimum/maximum materialization rates, minimum/maximum expected load factors, etc.

Other variations and modifications will be apparent to one of ordinary skill in the art.

### Hardware and Software Environment

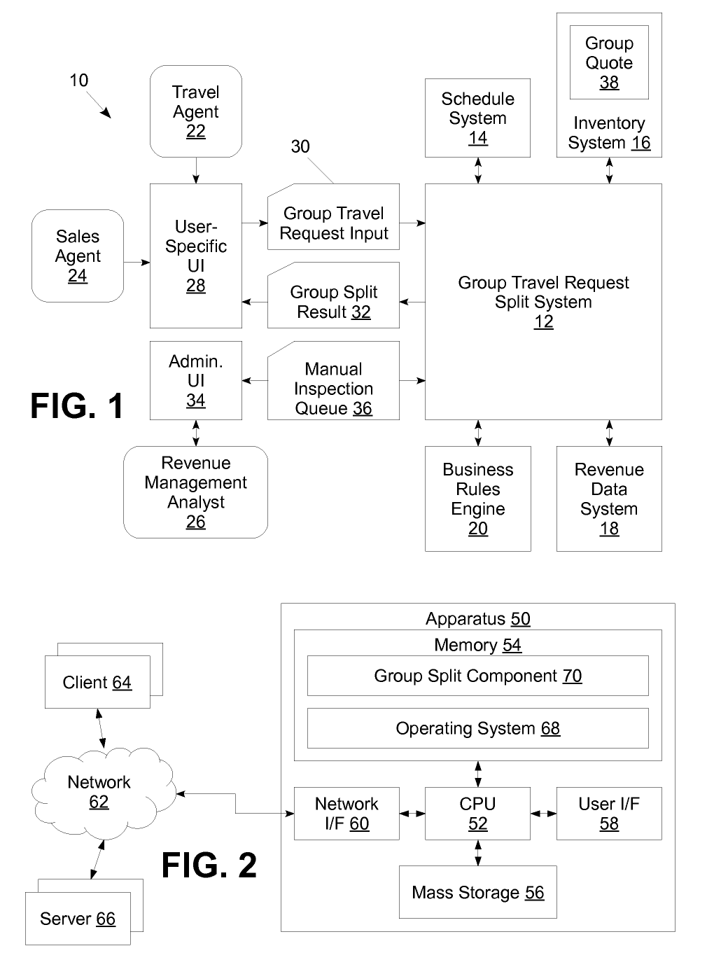

Turning now to the drawings, wherein like numbers denote like parts throughout the several views, FIG. 1 illustrates an exemplary data processing system 10 in which a revenue driven group travel request split operation may be implemented. System 10 is illustrated as including a central service implemented by a group travel request split computer system 12, which is interfaced with various additional travel-related computer services, e.g., a schedule system 14, an inventory system 16, a revenue data system 18 and a business rules engine 20. Schedule system 14 primarily provides travel solutions and flight schedule information for the flights that are available or in force for at least one airline, while inventory system 16 primarily provides flight inventory information such as capacity, availability and flight structure (cabins, booking classes, legs) of the flights that are present in the database, and revenue data system 18 provides revenue data such as bid price values and/or yield values that may be utilized to guide the group travel request split operation based upon revenue concerns. Business rules engine 20 provides and manages the business rules that enable a group travel request split operation to be customized for a particular travel provider.

It will be appreciated that systems 12, 14, 16 and/or 18 may be combined in some implementations and may be implemented within the same or in different computer systems. Moreover, systems 12, 14, 16 and/or 18 may be operated and/or managed by the same or different entities, e.g., a travel provider or a third party that supports multiple travel providers. Engine 20 may be dedicated to system 12 or may support additional systems 14, 16 and/or 18, or may be integrated into system 12. Furthermore, the functionality supported by engine 20 may be implemented without the use of a business rules-based methodology.

System 12 may be accessible by a number of different types of users, e.g., travel agents 22, sales agents 24 acting on behalf of a travel provider, and revenue management analysts 26 also acting on behalf of a travel provider. For agents 22, 24, a user-specific user interface 28 may be provided, e.g., to receive group travel requests 30 and to return group split results 32. For group desk officers 26 and other administration-level users, a separate administration user interface 34 may be supported, e.g., to handle manual inspection queue 36 items, discussed in greater detail below. Each user interface 28, 34 may be graphically based, e.g., based upon a web standard such as HTML, or using other interface architectures known in the art, e.g., other client-server interface architectures. Additional administration interfaces may also be supported consistent with the invention. In addition, in some implementations only travel provider representatives may be provided with access to system 12, whereby no access by agents 22 would be supported.

In addition, as will be discussed in greater detail below, group quote functionality may be supported in inventory system 16 in some embodiments, e.g., within a group quote module 38.

System 12 may be implemented in a number of manners consistent with the invention. FIG. 2, for example, illustrates an exemplary apparatus 50 within which various steps from a revenue driven group travel request split operation may be implemented in a manner consistent with the invention. For the purposes of the invention, computer 50 may represent practically any type of computer, computer system or other programmable electronic device. Moreover, computer 50 may be implemented using one or more networked computers, e.g., in a cluster or other distributed computing system, or may be implemented within a single computer or other programmable electronic device, e.g., a desktop computer, laptop computer, handheld computer, cell phone, set top box, etc.

Computer 50 typically includes a central processing unit 52 including at least one microprocessor coupled to a memory 54, which may represent the random access memory (RAM) devices comprising the main storage of computer 50, as well as any supplemental levels of memory, e.g., cache memories, non-volatile or backup memories (e.g., programmable or flash memories), read-only memories, etc. In addition, memory 54 may be considered to include memory storage physically located elsewhere in computer 50, e.g., any cache memory in a processor in CPU 52, as well as any storage capacity used as a virtual memory, e.g., as stored on a mass storage device 56 or on another computer coupled to computer 50. Computer 50 also typically receives a number of inputs and outputs for communicating information externally. For interface with a user or operator, computer 50 typically includes a user interface 58 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 50 may also include one or more mass storage devices 56, e.g., a floppy or other removable disk drive, a hard disk drive, a direct access storage device (DASD), an optical drive (e.g., a CD drive, a DVD drive, etc.), and/or a tape drive, among others. Furthermore, computer 50 may include an interface 60 with one or more networks 62 (e.g., a LAN, a WAN, a wireless network, and/or the Internet, among others) to permit the communication of information with other computers and electronic devices, e.g., one or more client computers 64 (e.g., for interfacing with agents 22, 24 and officers 26) and one or more servers 66 (e.g., implementing systems 14, 16, and 18 and engine 20). It should be appreciated that computer 50 typically includes suitable analog and/or digital interfaces between CPU 52 and each of components 54, 56, 58 and 60 as is well known in the art. Other hardware environments are contemplated within the context of the invention.

Computer 50 operates under the control of an operating system 68 and executes or otherwise relies upon various computer software applications, components, programs, objects, modules, data structures, etc., e.g., a group split component 70. Moreover, various applications, components, programs, objects, modules, etc. may also execute on one or more processors in another computer coupled to computer 50 via network 62, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium that can be used to store the desired information and which can be accessed by computer 50. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIGS. 1 and 2 is not intended to limit the present invention. Indeed, those skilled in the art will recognize that other alternative hardware and/or software environments may be used without departing from the scope of the invention.

### Revenue Driven Group Travel Request Split Operation

A revenue driven group request split operation consistent with the invention is typically based on several types of data. A first type of data that may be relevant to the group travel request split operation relates to request originator parameters, which may include, for example, identification information for the request originator, such as an identification number or code (ID) of the office originating the request and the geographical information of the request originator (i.e. the physical place on the world map wherein the request is actually originated).

A second type of data that may be relevant to the group request split operation relates to group travel request parameters. The group travel request parameters represent at least one part of the identifying parameters that are peculiar to each group involved in a group travel request. The group travel request input parameters may include at least one of the following: requested route (i.e. the overall path from the departure point to the arrival point of the journey), number in party (i.e. the physical number of seats included in the group request), requested travel date, additional group travel request data (e.g., travel cabin, group type: leisure, students, etc.), minimum size or quantity of a subgroup that defines a group compliance parameter, and schedule flexibility (e.g., flexibility on dates and/or time and flexibility on a route, such as whether additional connections are accepted, specific connection points are requested, etc.)

A third type of data that may be relevant to a group request split operation relates to flight inventory information. This data may include seat capacity at different levels (e.g., segment/cabin, leg/cabin, etc.), availability at different levels (e.g., segment/cabin, leg/cabin etc.), already existing group reservations at the time of the present group travel request is presented by the group request originator, and aircraft characteristics (e.g., aircraft type, etc.), among other.

A fourth type of data that may be relevant to the group request split operation relates to revenue controls. For example, the revenue data may include one or more of the materialization rate of the group request originator, leg/cabin expected to board, yield values, bid price values, etc.

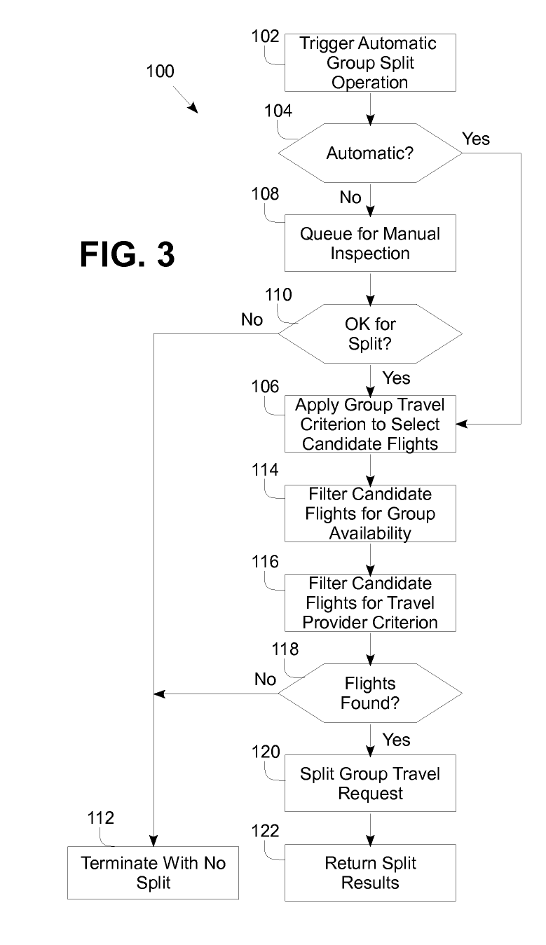

An exemplary implementation of a revenue driven group travel request splitting operation consistent with the invention is illustrated by process 100 in FIG. 3. As noted above, it may be desirable in some embodiments to utilize a business rules engine to provide a revenue driven approach for optimizing the group split operation. These rules typically determine the operation behavior depending on various criteria. For instance, a rule may be defined in order not to retain a flight date for the group split operation in case its expected load factor on a given route is more than 95%. The embodiment illustrated in FIG. 3 is based on such a rules-based implementation; however, the invention is not so limited in other embodiments, so the various criteria that control whether and how group split operations are performed may be implemented without the use of business rules in other embodiments.

As illustrated in block 102, process 100 may be initiated by automatically triggering a group split operation. Revenue driven group travel request split operations, in particular, may be triggered on behalf of either new group travel requests, initiated by a travel agent 22 or sales agent 24, or by group travel requests that have been queued for manual inspection by an officer 26 (FIG. 1). In addition, a group split operation is typically triggered depending upon at least one additional criterion, e.g., requested travel date, requested route board and off points, group request originator geographical information, number in party, and materialization rate of the group request originator. Put another way, group split operations are typically not required for all group travel requests, and instead are utilized for group travel requests that meet one or more group split acceptance rules.

In the illustrated embodiment, one or more group split acceptance rules may be defined in order to provide the functionality needed for automatic triggering. Table I, for example, shows a table including a first column indicating group request parameters and revenue controls capable of being used in an acceptance rule, a second column that defines, for each group request parameter or revenue control, a criterion for a rule, and a third column that describes the implementation and purpose of such a rule:

TABLE I

| Group request | Group split | |
|---|---|---|
| characteristics | acceptance rule | Comparison |
| Departure date | Start date | Check if the departure date is |
| | End date | between the start and end |
| | | dates, inclusive. |
| Board point | Departure market | Check if the board point |
| Off point | Arrival market | belongs to the departure |
| | | market and the off point |
| | | belongs to the arrival market. |
| Group request | Request originator | Check if the request originator |
| originator | point of sale | geographical location belongs |
| geographical | | to the request originator point |
| | | of sale. |
| Number in party | Minimum number in | Check if the number in party is |
| | party | between the minimum and |
| | Maximum number | maximum defined in the rule, |
| | in party | inclusive. |
| Materialization | Minimum | Check if the materialization |
| rate of the group | materialization rate | rate of the group request |
| request originator | Maximum | originator is between the |
| | materialization rate | minimum and maximum |
| | | materialization rates, inclusive. |

Returning to FIG. 3, after an operation is triggered in block 102, block 104 determines if a matching rule can be applied to the present group travel request, and if a matching rule that allows an automatic group split operation has been found, control passes to block 106 to trigger an automatic group split operation. If no matching rule is found or a rule matches but does not allow automatic group splitting, block 104 instead passes control to block 108 to queue the request for manual inspection.

For example, a rule may be defined to trigger an automatic group split operation for all requests from Nice to New York, from the 1st to the 3rd of July, for requests coming from group request originators in France and where the number in the party is between 30 and 60. Another rule may be defined to queue for manual inspection (i.e., to not allow automatic group splitting) for all group travel requests with a number in the party greater than 60.

Thus, for example, when a group travel request is queued in block 108, the manually queued group travel request may be displayed on a dedicated user interface (e.g., administration interface 34 of FIG. 1) so that the airline group revenue management analyst or other authorized entity can assess it (block 110). As a result, he/she may change the request if needed, start the group split operation or reject the request (thereby passing control from block 110 to block 112). In some embodiments, when starting a group split operation from the dedicated interface, an airline group revenue management analyst may choose to bypass the automatic group split operation triggering so that the automatic group split is started without checking the group split acceptance rule.

Once a group split operation has been initiated by passing control to block 106, a candidate flight selection process is initiated to determine a set of candidate flights, or travel solutions, for the group travel request. First, in the illustrated embodiment, a search is performed to select travel solutions matching a group travel criterion, e.g., by searching for all travel solutions operating on a requested route and on a requested data, optionally with added “schedule flexibility”. Schedule flexibility may refer to flexibility in terms of departure dates (date flexibility), time (time flexibility) and/or route (route flexibility). Route flexibility includes, for example, searching for travel solutions with various intermediate connections between the origin and destination points. In particular, schedule flexibility may include, for example, up to +/−7 days on the requested date and a time range, while route flexibility may include a specified maximum number of accepted connections and/or a specific connection airport if desired.

As a result of this operation, a set of candidate travel solutions are retrieved, e.g., by accessing schedule system 14 (FIG. 1). In the case of travel solutions with connections a list of linked segments per travel solution with their associated flights may also be returned. In case of travel solutions with no connections a segment per travel solution with its associated flight may be returned.

Next, in block 114, the candidate flights or travel solutions are filtered by segment/cabin group availability in order to avoid returning travel solutions with insufficient availability for groups. Filtering is performed to retain only segments with group segment/cabin availability superior to the minimum subgroup size provided in the input of the group split operation. This may be done by using a maximum group proportion rule and using parameters such as: from segments included in candidate travel solutions (i.e., retrieved from flight inventories): segment board and off points, segment departure date, already existing segment/cabin group bookings, segment/cabin capacity, and segment/cabin availability; and from group travel request parameters: minimum subgroup size and travel cabin. Based upon such parameters, a maximum group proportion rule may defined based on criteria such as departure market, arrival market, start date, end date and maximum accepted group proportion.

Block 114 searches for each segment for a matching rule by comparing segment and group travel request parameters with rule criteria, e.g., as illustrated in Table II:

TABLE II

| Candidate | | |
|---|---|---|
| flight/group | | |
| request | | |
| characteristics | Rule data | Comparison |
| Segment | Start date | Check if the segment departure |
| departure date | End date | date is between the start and end |
| | | dates, inclusive. |
| Segment | Departure market | Check if the segment board point |
| board point | Arrival market | belongs to the departure market |
| Segment | | and the segment off point |
| off point | | belongs to the arrival market. |

If a matching rule can be found, the maximum accepted group proportion is retrieved.

In the illustrated implementation, group segment/cabin availability may be calculated with the following formula, as the minimum within the product of the segment/cabin capacity and the maximum accepted group proportion minus the already existing segment/cabin group bookings and the segment/cabin availability):

GroupAvl_{seg/cabin}=min(Capacity_{seg/cabin}·MAGP−GrpBookings_{seg/cabin},Avl_{seg/cabin})

where GroupAvl_{seg/cabin} represents segment/cabin group availability, Capacity_{seg/cabin} represents segment/cabin capacity, MAGP represents maximum accepted group proportion, GrpBookings_{seg/cabin} represents already existing segment/cabin group bookings and Avl_{seg/cabin} represents segment/cabin availability. If no rule is defined then the segment/cabin group availability equals to the segment/cabin availability.

The calculated segment/cabin group availability is then compared to the minimum subgroup size, and if the segment/cabin group availability is lower than the minimum subgroup size then the concerned segment and the candidate travel solutions that include it are discarded. For all remaining candidate travel solutions, travel solution/cabin group availability may be calculated as the minimum value among the previously computed segment/cabin group availabilities of the segments included in the travel solution.

Next, in block 116, candidate flights or travel solutions are filtered based upon a travel provider criterion. In particular, block 116 takes into account additional flight parameters and revenue controls that allow for fine-tuning the selection process based on the airline group business policy, and allows an additional segment ranking and selection performed by using one or of the following: segment board and off points, segment departure date, flight parameters such as aircraft type, already existing segment/cabin group bookings, segment/cabin capacity, materialization rate of the group request originator (typically retrieved from a revenue management system based on group travel request parameters) and segment/cabin expected load factor.

A further set of additional rules may be added per segment, departure date period and aircraft characteristics in the scope of segment ranking, and may be based on a group proportion ranking rule, a materialization rate ranking rule, and an expected load factor ranking rule.

A group proportion ranking rule may be based on parameters such as departure market, arrival market, start date, end date, aircraft characteristics such as aircraft type, minimum segment/cabin group proportion, maximum segment/cabin group proportion, a ranking between 0% and 100% and a weight between 0 and 10. A materialization rate ranking rule may be based on parameters such as departure market, arrival market, start date, end date, aircraft characteristics such as aircraft type, minimum materialization rate, maximum materialization rate, a ranking between 0% and 100% and a weight between 0 and 10. An expected load factor ranking rule may be based on parameters such as departure market, arrival market, start date, end date, aircraft characteristics such as aircraft type, minimum segment/cabin expected load factor, maximum segment/cabin expected load factor, a ranking between 0% and 100% and a weight between 0 and 10.

The Group proportion ranking rule, the Materialization rate ranking rule and the Expected load factor ranking rule may define a ranking between 0% and 100% depending on the segment/cabin group proportion, the materialization rate of the request originator and the segment/cabin expected load factor. A weight may also be defined for each of the specific rankings.

Block 116 searches matching rules by comparing segment and flight parameters as well as revenue controls with rule criteria such as illustrated in Table III:

TABLE III

| Candidate flight/Group | | |
|---|---|---|
| request characteristics | Rule data | Comparison |
| Segment departure date | Start date | Check if the segment |
| | End date | departure date is between |
| | | the start and end dates, |
| | | inclusive. |
| Segment board point | Departure market | Check if the segment |
| Segment off point | Arrival market | board point belongs to the |
| | | departure market and the |
| | | segment off point belongs |
| | | to the arrival market. |
| Candidate flight aircraft | Aircraft characteristics: | Check if the aircraft type of |
| type | aircraft type | the candidate flight is the |
| | | same as the one in the |
| | | rule. |
| For group proportion | For group proportion | For group proportion |
| selection only: | selection only: | selection only: |
| Already existing cabin | Minimum cabin group | Check that the ratio |
| group reservations | proportion | between the already |
| Flight cabin capacity | Maximum cabin group | existing group |
| | proportion | reservations on a given |
| | | cabin and the cabin |
| | | capacity is between the |
| | | minimum and maximum |
| | | group proportion defined |
| | | in the rule, inclusive. |
| For materialization rate | For materialization rate | For materialization rate |
| selection rule only: | selection rule only: | selection rule only: |
| Materialization rate of the | Minimum materialization | Check that the |
| group request originator | rate | materialization rate of the |
| | Maximum materialization | group request originator is |
| | rate | between the minimum and |
| | | maximum materialization |
| | | rates, inclusive. |
| For expected load | For expected load factor | For expected load factor |
| factor selection rule | selection rule only: | selection rule only: |
| only: | Minimum cabin expected | Check that the expected |
| Expected cabin load | load factor | cabin load factor is |
| factor | Maximum cabin expected | between the minimum and |
| | load factor | the maximum cabin |
| | | expected load factors, |
| | | inclusive. |

For each segment included in the set of candidate travel solutions specific rankings and their weights are retrieved from the group proportion, materialization rate and expected load factor ranking rules disclosed in Table III. A total ranking is calculated for each segment as the weighted mean of the specific rankings that could be retrieved, using the weights defined in the specific rules. If no specific rankings could be retrieved at all, no total selection ranking is calculated.

At this step each segment has a total ranking calculated based on the specific ranking rules presented above. In the scope of segment selection, an additional segment selection rule may be defined with the following criteria: Departure market, Arrival market, Start date, End date, Aircraft characteristics such as aircraft type and Acceptance ranking level for a given cabin. The Segment selection rules define acceptance ranking levels for which segments can be discarded or kept. As such, for the segments for which the total ranking could be computed, the total ranking is compared with the acceptance ranking level retrieved from the segment selection rule. If the total ranking is lower than the acceptance ranking level, the concerned segment and all candidate travel solutions which include it are discarded. The segments for which no total ranking could be calculated or no segment selection rule could be retrieved may be kept.

As a non-limiting example, consider a request that is received from a request originator with the materialization rate of 70%, and for a segment to rank and select or discard the following specific rankings are defined:
for a materialization rate of 70%, a materialization rate ranking rule defines a ranking of 80% with a weight of 9 (out of 10).
a group proportion calculated from flight inventory parameters for the segment/cabin is 10% and the group proportion ranking rule defines a ranking of 60% with a weight of 5 (out of 10).
a segment/cabin expected load factor on the segment is 95% and the expected load factor rule provides a ranking of 50% with a weight of 7 (out of 10).

Based upon these rules, the total ranking would be:

Total ranking=(80%*9+60%*5+50%*7)/(9+5+7)=1370%/21=65.24%.

Further, a segment selection rule may be defined for the requested segment/cabin with an acceptance ranking level of 75%, whereby the total ranking of 65.24% of the segment would result in the segment being discarded, such that all travel solutions including the segment would be removed from the set of candidate travel solutions.

Thus, in the illustrated embodiment, a set of candidate travel solutions is developed by first applying a group travel criterion to identify an initial set of candidate travel solutions, filtering that initial set based on group availability, and then further filtering that set by a travel provider criterion. It will be appreciated, however, that in other embodiments, the set of candidate travel solutions may be determined in other manners, e.g., by merging the filtering operations or performing a single search incorporating all of the criteria discussed above. Therefore, the invention is not limited to the specific implementation discussed herein.

Next, block 116 passes control to block 118 to determine whether any flights or travel solutions have been found. If not, control passes to block 112 to terminate process 100 without splitting the group travel request. Otherwise, control passes to block 120 to perform the group travel request split operation. The results of this operation are then returned to the originator of the group travel request in block 122, and process 100 is complete. The results output in block 122, for example, may be provided in the form of a plurality of travel solutions with an associated subgroup size or quantity for each, along with a group quote. In the illustrated embodiment, the group quote is the sum of the adjusted unitary displacement costs on all the travel solution with subgroups. The end user of such information may be an airline sales agent or airline group revenue management analyst, or in some instances, a travel agent (where the quote may be adjusted to calculate a proposal price for the group travel request). The results of the computation, when provided to a sales agent or group revenue management analyst may be used to build a commercial proposal with travel solutions, subgroups and a price, which may be computed, for example, by applying an additional negotiation margin.

In the illustrated embodiment, the group travel request split operation performed in block 120 relies on parameters such as: travel solution board and off points, travel solution departure dates, travel solution structure including segments and legs, requested travel cabin, travel solution/booking class availabilities of the booking classes included in the requested travel cabin, group travel solution/cabin availability calculated during the selection of candidate travel solutions, the materialization rate of the request originator, request originator geographical information, minimum subgroup size or quantity, and revenue data. Typically, a travel provider may have a choice of using revenue data such as yields or bid price vectors, although both types of revenue data may be used in some implementations. Moreover, in the illustrated embodiment, the group travel request split operation may respect constraints such as minimum subgroup quantity (i.e., each candidate travel solution on which inventory is allocated for the group travel request must contain at least the number of inventory items equivalent to the minimum subgroup size or quantity), travel solution/cabin group availability (i.e., the subgroup quantity allocated to a travel solution may not exceed the travel solution/cabin group availability), and lowest group quote (i.e., when performing the group split operation, block 120 may allocate subgroup quantities to candidate travel solutions in order to obtain the lowest group quote.

In the illustrated embodiment, a group split operation is revenue driven based upon the concept of displacement cost used as carrier revenue optimization parameter. The displacement cost concept relates to the expected revenue, or opportunity cost, that could be obtained by accepting an individual booking instead of allocating it to a group travel request, i.e., the expected effect on the revenue of the travel provider resulting from displacement of an inventory item from an individual booking to a group travel request. The displacement cost is generally determined based upon adjusting a unitary displacement cost value, which is the revenue that an airline expects by accepting an individual booking for an inventory item on a travel solution and cabin instead of allocating it to a group travel request. The adjustment of the unitary displacement cost is based upon an adjustment factor, which is described in greater detail below.

Thus, when computing a group quote by using displacement cost, block 120 ensures that the revenue expected from a group travel request takes into account the revenue that could have otherwise been earned by selling inventory items as individual (non-group) bookings.

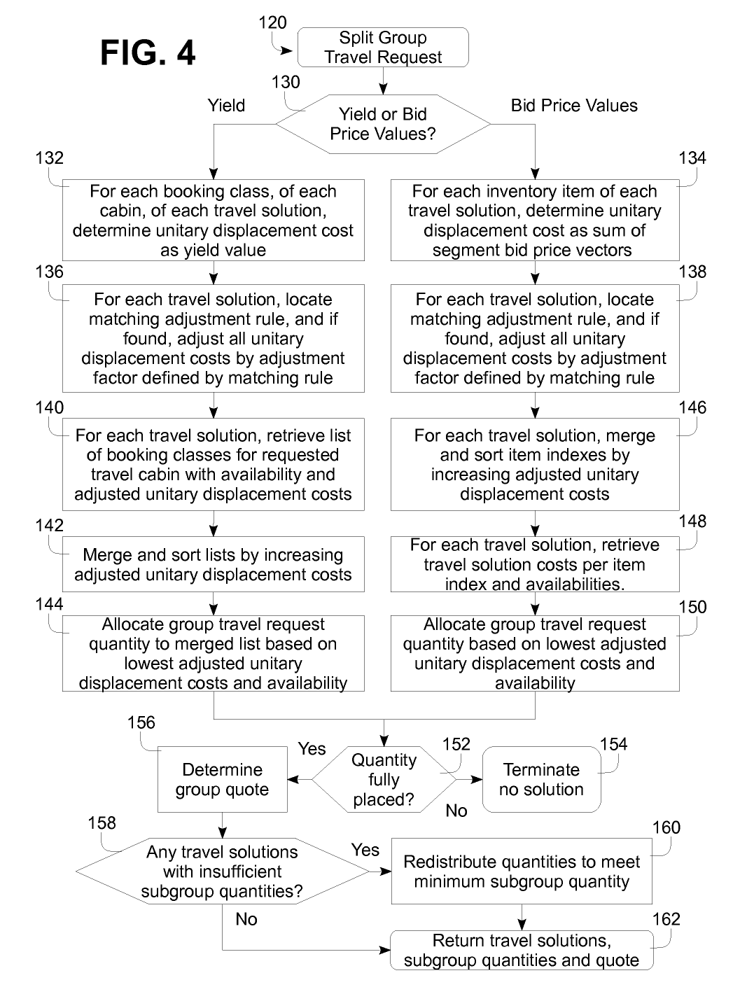

Block 120 is illustrated in greater detail in FIG. 4, and begins in block 130 by determining, e.g., from a system setting, which revenue controls to use: yields or bid price vectors. Once the revenue controls to use have been selected, the unitary displacement cost per relevant booking class of the requested travel cabin is determined by using travel solution level yields or per requested travel cabin item index by using bid price vectors or values, according to the revenue controls that have been selected.

In the case of yield usage, and as shown in block 132, the relevant booking classes per requested travel cabin are retrieved from inventory system 16 and the unitary displacement cost for a travel solution and an inventory item in the concerned booking class is determined to be equal to the travel solution level yield value of the concerned booking class. For example, Table IV illustrates an example calculation of unitary displacement costs for a particular travel solution based on yield values:

TABLE IV

| Booking | | Unitary displacement cost = |
|---|---|---|
| class | Yield | yield value |
| M | 344 | 344 |
| B | 344 | 344 |
| O | 319 | 319 |
| G | 304 | 304 |
| X | 294 | 294 |
| Z | 144 | 144 |

In case of bid price usage, as shown in block 134, leg/cabin bid prices are summed starting from the current item indexes and down to the lowest item indexes in order to obtain travel solution/cabin level bid price vectors (as defined above, a travel solution is formed of a segment which is formed of legs) and the unitary displacement cost for a travel solution and per item index is equal to the travel solution/cabin level computed bid price value for the concerned item index. For example, Table V illustrates an example calculation of unitary displacement costs for a particular travel solution based on bid price vectors, where the travel solution includes two legs with an intermediate connection B within the departure point A and the final arrival point C, and where the unitary displacement cost on the travel solution/cabin is calculated as the sum of the leg/cabin bid price vectors starting from the current item indexes (11 for the leg A-B and 13 for the leg B-C) and down to the lowest item index from the departure point A to the intermediate connection B and from the intermediate connection B to the final arrival point C:

TABLE V

| Item | Bid price | Bid price | Unitary displacement |
|---|---|---|---|
| index | A-B | B-C | cost |
| 1 | 949 | 664 | 1613 |
| 2 | 530 | 347 | 877 |
| 3 | 401 | 230 | 631 |
| 4 | 372 | 152 | 524 |
| 5 | 364 | 103 | 467 |
| 6 | 350 | 74 | 424 |
| 7 | 327 | 54 | 381 |
| 8 | 295 | 36 | 331 |
| 9 | 258 | 23 | 281 |
| 10 | 220 | 13 | 233 |
| 11 | 185 | 7 | 192 |

While in some embodiments, the unitary displacement cost need not be adjusted, in the illustrated embodiment it is desirable to adjust the unitary displacement cost by an adjustment factor at a travel solution level in order to better reflect a carrier group revenue management policy, as illustrated in blocks 136 and 138. Desirably, the adjustment factor at travel solution level is retrieved from an adjustment rule using parameters such as the travel solution board point and off point, the travel solution departure date, the requested travel cabin, the group request originator geographical information and the group request originator materialization rate. In addition, the adjustment rule may be defined with one or more of the following parameters: departure market, arrival market, start date, end date, minimum materialization rate, maximum materialization rate, group request originator point of sale and adjustment factor for a requested cabin, e.g., as illustrated below in Table VI:

TABLE VI

| Candidate route/Group | | |
|---|---|---|
| request characteristics | Rule data | Comparison |
| Travel solution departure | Start date | Check if the travel solution |
| date | End date | departure date is between |
| | | the start and end dates, |
| | | inclusive. |
| Travel solution board | Departure market | Check if the travel solution |
| point | Arrival market | board point belongs to the |
| Travel solution off point | | departure market and the |
| | | travel solution off point |
| | | belongs to the arrival |
| | | market. |
| The maximum of | Minimum cabin expected | Check if the request cabin |
| requested cabin load | load factor | load factor at travel |
| factors on all the | Maximum cabin expected | solution level is between |
| segments composing the | load factor | the minimum and the |
| travel solutions | | maximum cabin expected |
| | | load factors, inclusive. |
| Materialization rate of the | Minimum materialization | Check that the |
| group request originator | rate | materialization rate of the |
| | Maximum materialization | group request originator is |
| | rate | between the minimum and |
| | | maximum materialization |
| | | rates, inclusive. |
| Group request originator | Request originator point of | Check if request originator |
| geographical information | sale | geographical location |
| | | belongs to the request |
| | | originator point of sale. |

The Adjustment rule desirably defines an adjustment factor greater than 0% and which is used in the adjusted unitary displacement cost computation as follows:

UnitAdjDispCost_{TravelSolution/seat}=UnitDispCost_{TravelSolution/seat}*(AdjFactor_{TravelSolution/seat}/100)

where UnitAdjDispCost_{TravelSolution/seat} is the adjusted unitary displacement cost for a seat on a candidate travel solution, UnitDispCost_{TravelSolution/seat} is the unitary displacement cost for a seat on a candidate travel solution and AdjFactor_{TravelSolution/seat} is the adjustment factor at travel solution level retrieved from the adjustment rule. In case no adjustment rule can be found, the adjusted unitary displacement cost equals to the unitary displacement cost. As a result, the adjusted unitary displacement cost is determined for all travel solutions.

After the adjusted unitary displacement cost has been completely calculated, the group quantity specified by the group travel request is split in a revenue driven manner. First, in case of yield usage, and as illustrated in block 140, for all the candidate travel solutions, the lists of booking classes belonging to the requested travel cabin with their travel solution/booking class availability and adjusted unitary displacement costs are retrieved. Then, in block 142, the lists of booking classes belonging to the requested travel cabin with their travel solution/booking class availability and adjusted unitary displacement costs are merged together and sorted according to an increasing adjusted displacement cost.

Next, in block 144, the group travel request quantity is then allocated in the merged list starting from the lowest adjusted unitary displacement cost and according to the provided availability as described further. In any case, for a travel solution, the amount of displaced seats cannot exceed the group travel solution/cabin availability. Every time an inventory item is displaced on a travel solution, the group travel solution/cabin availability is decreased by one and once the group travel solution/cabin availability is equal to zero no more inventory items can be displaced. Moreover, in case of unitary displacement cost computation based on yields, the travel solution/booking class availability may also be used in addition to the group travel solution/cabin availability. The inventory items may be displaced starting with the booking class with the lowest adjusted unitary displacement cost and on each booking class it is possible to displace a maximum number of inventory items equal to the travel solution/booking class availability. There may be cases when different travel solutions share a common segment and therefore the same cabin and booking class availability. In such a case, the cabin and booking class availability of the other travel solutions that share the segment may also be decreased.

Returning to block 138, after calculating the adjusted unitary displacement costs using bid price vectors, for each travel solution the adjusted unitary displacement costs per item index are merged together and then sorted according to increasing adjusted unitary displacement cost, as shown in block 146. Then, in block 148, the travel solution adjusted unitary displacement costs per item index computed from travel solution level bid prices for the candidate travel solutions are retrieved. The group travel solution/cabin availability which has been computed in the candidate travel solutions selection part is also retrieved. Then, in block 150, the group travel request quantity is allocated starting from the lowest adjusted unitary displacement costs based on group travel solution/cabin availability, and the item index of travel solution adjusted unitary displacement costs to limit the number of seats that can be allocated to the concerned travel solution. The group travel request quantity is displaced starting with the lowest adjusted unitary displacement cost and the amount of inventory items displaced is not permitted to exceed the item index value. In addition, there may be cases when different travel solutions share a common segment and therefore the same availability. In such a case, the group travel solution availability of the other travel solutions that share the segment is also typically decreased. The adjusted unitary displacement cost for the other travel solutions that share the segment may be recomputed in the same manner described in steps 134 and 138. The computation then continues with the new recomputed adjusted unitary displacement costs and group travel solution/cabin availability.

In case the entire group travel request could not be placed as there was no sufficient availability in all travel solutions, the group split process is finished with no solutions. Thus, blocks 144 and 150 pass control to block 152 to determine if the quantity associated with the group travel request was fully placed, and if not control passes to block 154 to terminate the routine with no solution identified.

Otherwise, control passes to block 156 to calculate a group quote corresponding to the displacement performed. Then, control passes to block 158 to determine whether any travel solutions exist with subgroups having a lower quantity than the minimum subgroup size or quantity. If so, control passes to block 160 to redistribute the subgroup quantities to meet the minimum subgroup size parameter. Once all subgroup quantities meet this parameter, the results of the operation, including the final group quote, along with the travel solutions and subgroup quantities allocated thereto, are returned in block 162 and block 120 is complete.

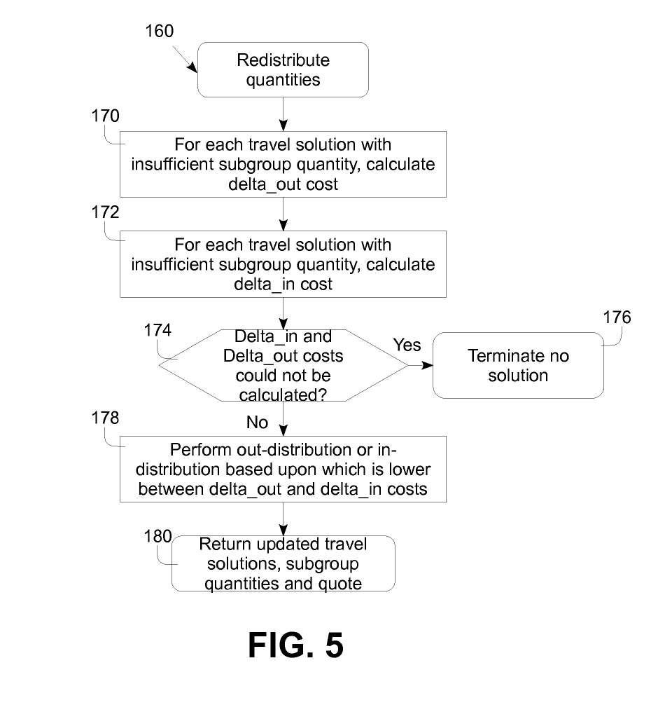

As noted above, block 160, if necessary, redistributes the group travel request quantity among the subgroup quantities if any travel solution has a subgroups with a size lower than the minimum subgroup size. As shown in FIG. 5, first, for every travel solution with insufficient subgroup quantity, a delta_out cost for distributing out all inventory items from the travel solution with insufficient subgroup quantity to the other travel solutions is calculated (block 170). The delta_out cost for this out-distribution operation equals the difference between the group quote after the out-distribution operation and the previous group quote before the out-distribution operation. The out-distribution of all the inventory items from the impacted travel solution to the other travel solutions is performed on the merged list built and filled with inventory items previously generated and from which the adjusted unitary displacement costs belonging to the impacted travel solution with insufficient subgroup size have been removed. All the seats of the impacted travel solution with insufficient subgroup size are replaced on this new merged list already filled with inventory items for the other travel solutions starting with the lowest available adjusted unitary displacement cost and at the end of this operation a new group quote after the out-distribution operation is determined. If it is not possible to replace all the inventory items, no delta_out for this out-distribution operation is calculated. The purpose of this step is to calculate the cost of an out-distribution operation which could be performed; however, no real out-distribution of inventory items is actually performed at this point.

Next, for every travel solution with insufficient subgroup size, a delta_in cost of reaching the minimum subgroup size by distributing in an extra number of seats from the other travel solutions with extra subgroup size (i.e. travel solutions on which more inventory items than the minimum subgroup size have been placed) to the impacted travel solution with insufficient subgroup size or by distributing in inventory items from the other travel solutions with insufficient subgroup size is determined (block 172). The delta_in cost for this in-distribution operation equals the difference between the group quote after the in-distribution operation and the previous group quote before the in-distribution operation. The in-distribution of inventory items from other travel solutions to the impacted travel solution with insufficient subgroup size is based on the merged list built and filled with inventory items previously generated and from which the adjusted unitary displacement costs belonging to the impacted travel solution with insufficient subgroup size have been removed. From this new merged list, the system starts removing inventory items from the highest to the lowest adjusted unitary displacement costs in order to place them into the impacted travel solution and by respecting the following conditions: (1) the travel solution from which the inventory item is removed is itself with insufficient subgroup size or (2) the travel solution is with sufficient subgroup size and removing the inventory item does not transform it into a travel solution with insufficient subgroup size.

In case the condition above is not respected, the inventory item is not removed and the system goes to the following inventory item. If the minimum subgroup size is reached for the impacted travel solution with insufficient subgroup size, the new group quote after the in-distribution can be obtained. If, after having replaced all possible inventory items, the minimum subgroup size is not reached for the impacted travel solution with insufficient subgroup size, the delta_in value is not calculated. The purpose of this step is to calculate the cost of an in-distribution operation which could be performed; however, no real in-distribution of inventory items is actually performed at this point.

Next, in block 174, if no delta_out or delta_in value could be calculated, control passes to block 176, and the group split process is finished with no solutions. Otherwise, control passes to block 178 to perform either the out-distribution or in-distribution operation based upon whether the delta_out value or delta_in value is lower. If an out-distribution operation has been chosen, the impacted travel solution with insufficient availability is removed from the list of travel solutions to use, and if an in-distribution operation has been chosen, the impacted travel solution now has sufficient subgroup size. As such, the updated travel solutions, subgroup quantities and quote are returned in block 180.

### Group Split Example Based on Yields

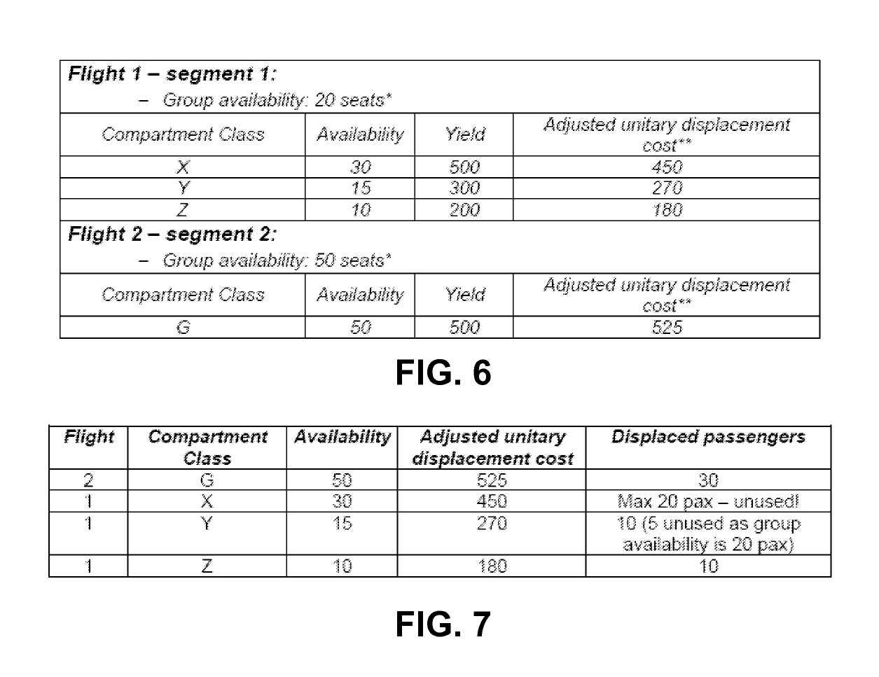

To further illustrate the operation of a revenue driven group travel request split operation, consider an example group travel request for 50 travelers has been received with a minimum subgroup size constraint of 20. FIG. 6, for example, illustrates a table with a set of candidate flights or travel solutions determined in the manner described above. In addition, in the table, group travel solution/cabin availabilities have been calculated, and the adjusted unitary displacement cost on the first travel solution is determined to be 90% of the unitary displacement cost while on travel solution 2 it is determined to be 105% of the unitary displacement cost (e.g., as determined from two matching adjustment rules respectively applying to travel solution 1 and travel solution 2).

As shown in FIG. 7, when attempting to perform a group split operation, a merged and sorted list may be generated from the two travel solutions in FIG. 6, and since the minimum group size constraint is respected on both travel solutions, no redistribution is required and the final split result is the following:

20 seats on segment/travel solution 1

30 seats on segment/travel solution 2

group quote=10*180+10*270+30*525=20250

Without the group travel request split operation disclosed herein, since the whole group travel request for 50 travelers could have been accepted only on travel solution 2, the displacement cost would have been 50*525=26250. Therefore, the group quote may be reduced by 6000 while still applying group revenue management controls. Such a reduction of group quote allows proposing better prices to group request originators and therefore provides a competitive advantage over carriers not performing a group split operation. Furthermore, the potential adverse impact of cancellations and an inability to replace with individual bookings is minimized given the distribution of the group quantity among multiple travel solutions.

Group Split Example Based on Bid Price Vectors and with Redistribution

Consider now the example of an airline using bid price vectors, where the request is for 50 travelers with a minimum subgroup size of 15 seats. The group travel solution/cabin availability is higher than 50 seats on each travel solution.

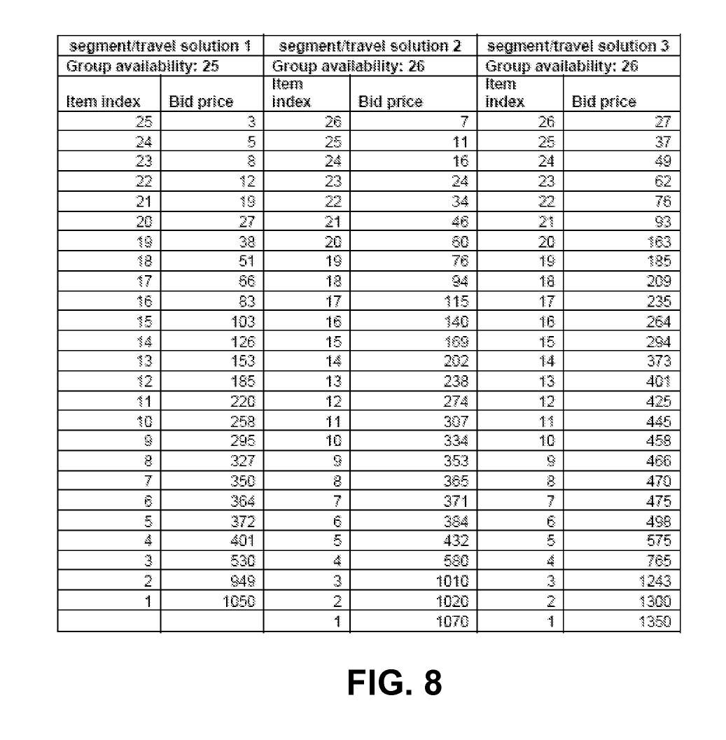

The table of FIG. 8 discloses three travel solutions together with their corresponding adjusted unitary displacement cost per item index.

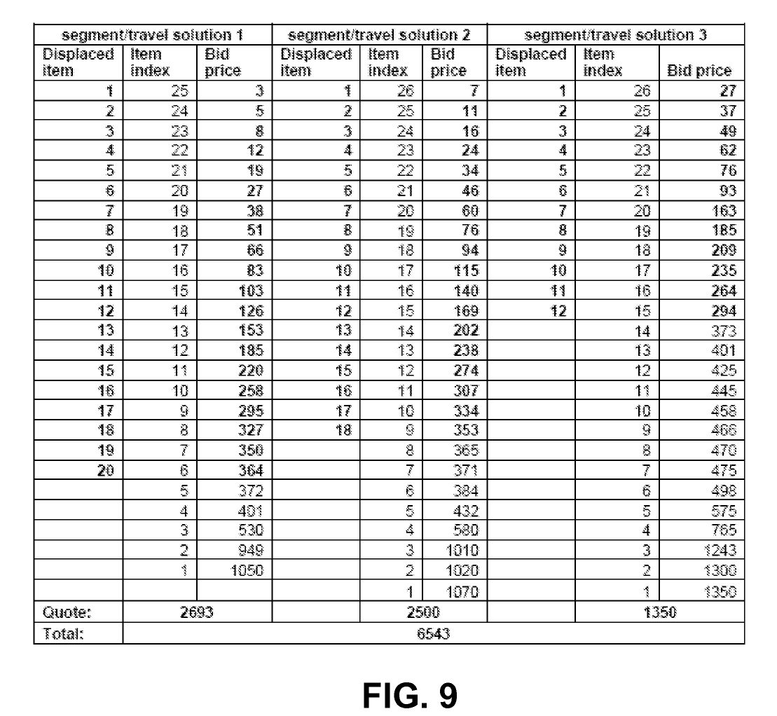

After having merged the adjusted unitary displacement costs for the three travel solutions in the manner disclosed above in connection with block 146 of FIG. 4, the 50 seats may be displaced starting with the lowest adjusted unitary displacement cost. The result is presented in FIG. 9. According to that table, once the seat displacement in the order of increasing adjusted unitary displacement cost of all 50 seats has been completed, travel solution number 3 notably does not satisfy the requirement of having an at least minimum subgroup size of 15. As such, it may be desirable to redistribute subgroup quantities in the manner disclosed above in connection with FIG. 5.

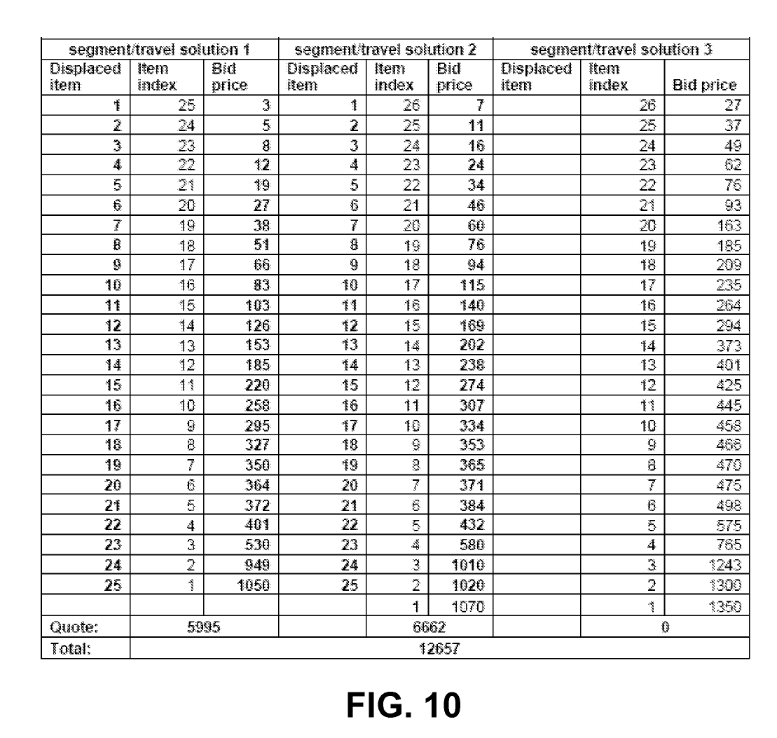

FIG. 10 illustrates the calculation of the delta_out value as discussed above in connection with block 170 of FIG. 5, which is the cost of distributing out all the inventory items from the travel solution 3 to the other two travel solutions. The delta_out cost is then the difference between the new group quote after the out-distribution (see FIG. 10) and the group quote before the out-distribution (see FIG. 9):

delta_out=12657−6543=6114

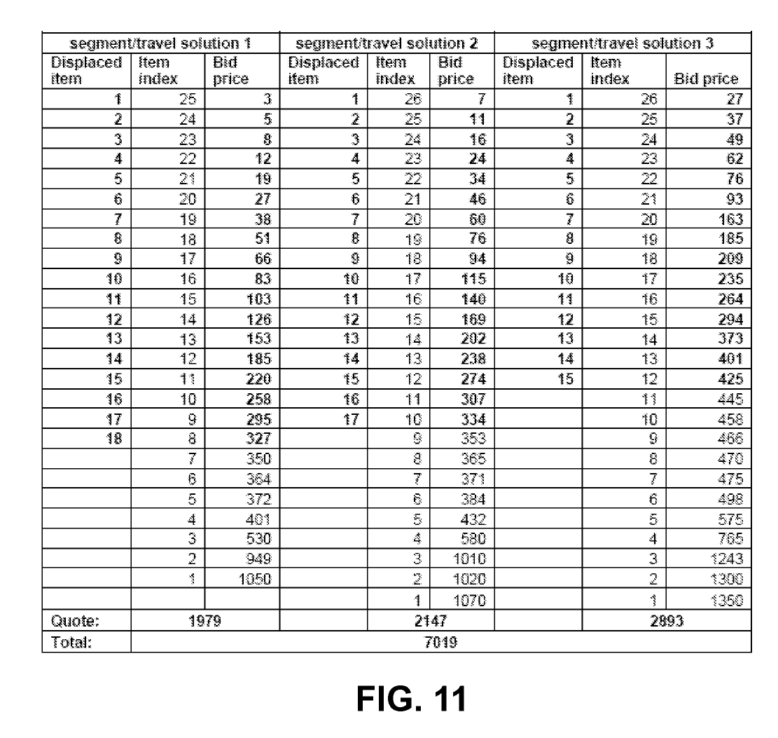

As previously discussed in connection with block 172 of FIG. 5, the delta_in value for the impacted travel solution 3 is calculated as the cost of redistributing the inventory items in excess from other travel solutions (travel solutions 1 and 2) or the inventory items from other travel solutions with insufficient subgroup size (no other travel solutions with insufficient subgroup size in this example) to the impacted travel solution with an insufficient subgroup size (travel solution 3) until the minimum subgroup size is reached. In the current example, the above redistribution of inventory items starts from the highest adjusted unitary displacement costs that correspond to an excess of displaced seats (here, to the displaced inventory items above 15 in travel solutions 1 and 2) in FIG. 9. After the redistribution of inventory items, illustrated in FIG. 11, two inventory items have been taken from travel solution 1 and one inventory item has been taken from travel solution 2. The delta_in cost is then the difference between the new group quote after the in-distribution (see FIG. 11) and the group quote before the in-distribution (see FIG. 9):

delta_in=7019−6453=476

As delta_in is lower than delta_out, block 178 of FIG. 5 uses the distribution corresponding to the delta_in operation. As there are no more travel solutions with insufficient subgroup size, the final split result is the following:

18 seats on travel solution 1

17 seats on travel solution 2

15 seats on travel solution 3

the group quote is 7019

In addition, it should be noted that, were splitting not performed in the manner disclosed herein, the group travel request for 50 travelers would have been rejected due to insufficient availability. Indeed, travel solutions 1, 2 and 3 have an availability limited by their respective item index:

25 seats on travel solution 1

26 seats on travel solution 2

26 seats on travel solution 3

One of the advantages of the revenue driven group travel request split operation, as well as the redistribution functionality described in connection therewith is the fact that it operates on data that has only been retrieved at the beginning of the operation. This thus advantageously leads to the fact that the number of database transactions is minimized, thus being cost effective and fast, and reducing energy consumption and processor and/or communication bandwidth. In addition, the integration with inventory and schedule systems allows for real-time data, thereby ensuring a more accurate and revenue optimized result based upon current circumstances.

As such, airline sales and/or airline group revenue management analysts may receive an optimized solution for accommodating a group travel request among several travel solutions automatically retrieved and selected. As this is done while minimizing the cost and/or limiting the risks of revenue loss, airline sales and/or group revenue management analysts are then typically capable of building the best offer to group request originators, such as a travel agency. As a result, a group split operation is typically fine-tuned to a level that suits to the optimization of an airline's group business need. In addition, in many instances embodiments of the invention may increase airline revenue by steering group travel requests towards flights with low demand, by taking into account revenue management forecasts when establishing the revenue expected from a group travel request, etc.

### Group Quote Operation Integrated into Inventory System

Consistent with another aspect of the invention, an automated group quote system may be implemented in a travel provider inventory system to facilitate generating quotes for group travel requests. Embodiments consistent with the invention, in particular, may operate in parallel with conventional revenue management systems, and allow revenue management systems to continue to focus on individual bookings while supplementing such functionality to provide a revenue driven manner to handle group bookings that accounts for the unique aspects of group bookings. As will be discussed in greater detail below, such functionality may utilize the aforementioned concept of displacement cost to calculate a group quote. In addition, while this aspect of the invention may be utilized in connection with generating group quotes for various types of travel providers and in connection with other travel industry applications, the discussion hereinafter will focus specifically on airlines. The invention, however, is not limited to an airline-based application.

This aspect of the invention may be implemented, for example, in a group quotation module or component incorporated into an airline's inventory system. In one aspect of the invention, a quote computation is performed by first computing a displacement cost from an airline's current inventory and revenue data for each requested reference airline trip segment. Business rules, or other adjustments, may then be applied to adjust the displacement cost based upon the context of the group travel request (e.g., characteristics of the requested segments, of the whole trip, of the requestor, etc.). Thereafter, an interline group quote corresponding to other airline segments may be added to generate a total group quote.

In the discussion hereinafter, a distinction is made between two types of airline segments. One type, referred to as a reference airline segment, is a segment on which the reference airline (i.e., the validating carrier) controls at least a part of the inventory as well as the fares applied to this inventory, and for which the airline has inventory counters and revenue data. Of note, a reference airline segment may include segments operated by the reference airline, as well as segments marketed by the reference airline under a blockspace codeshare agreement. The other type, referred to as an other airline segment, is any other segment that does not meet the aforementioned definition of a reference airline segment, and includes, for example, flights operated and marketed by other airlines, and flights that are marketed by the reference airline under a free-flow codeshare (interline) agreement.

A group quote operation may utilize various types of inventory data in connection with generating a group quote. For example, for a reference airline segment, a group quote operation may utilize data such as availability data (e.g., a booking counter) and revenue data such as yields or bid-prices, which are provided to the inventory system by a revenue management system or a yield management system, to calculate a segment quote. For other airline segments, a segment quote may be calculated using a business rule corresponding to an interlining agreement signed with the reference airline.

In one embodiment, for example, a total group quote may be computed as follows:

$$TotalGroupQuote = {\sum }_{{Segments operated}_{by Ref . Air .}}^{ } GroupQuote + {\sum }_{{Segments Ref . Air .}_{blockspace} }^{ } GroupQuote + {\sum }_{\begin{matrix}Segments operated by \\ Other Airline Excluding Blockspace\end{matrix}}^{ } InterlineAgreement$$

By integrating group quote functionality into an inventory system, a number of advantages may be realized. For example, since revenue management system (RMS) data (e.g., yields or bid-prices) is typically more static than inventory data (e.g., booking counters), calculating a group quote in the inventory system rather than a revenue management system allows for up-to-date and accurate data to be utilized with minimal synchronization between the inventory and revenue management systems, thereby optimizing accuracy while minimizing system overhead. In many instances, a daily feed from the revenue management system would be sufficient for most airlines, whereas in contrast, implementation of group quote functionality within a revenue management system might otherwise require inventory data to be retrieved from the inventory system every time a group quote operation was performed in order to ensure that up-to-date and accurate inventory data was available when calculating a group quote.

In addition, by incorporating a group quote operation in an inventory system, the operation does not depend directly from the revenue management system. As such, the operation may be implemented by airlines that do not have such systems, or airlines whose revenue management systems do not support group requests.

Furthermore, a group quote operation may benefit from the revenue optimization strategy of a reference airline, which is applied to revenue and availability data, such as yields, bid-prices and booking classes availability provided to the inventory system (whether using an automated revenue management system or not). In addition, in some embodiments adjustment rules enable a group quote to be fine tuned according to the characteristics of the group travel request and of the requestor, as well as take into account additional group-specific constraints.

Embodiments of the invention may be used, for example, by airline sales agents or group revenue management analysts as an aid in determining a quote for a group travel request, by providing an automated evaluation that is based on current inventory and revenue data and consistent with airline revenue management. By doing so, time and effort is saved through automation of the initial evaluation process, while bringing greater objectivity and consistency to the overall group quotation process.

As noted above, group quote operations may be supported as a component or module within an inventory system, e.g., as shown by group quote module 38 in inventory system 16 of FIG. 1. In addition, group quote module 38 may rely on a business rules engine such as engine 20 of FIG. 1 to implement some or all of the customizations desired by a particular travel provider, although other customization methodologies may be used in the alternative.

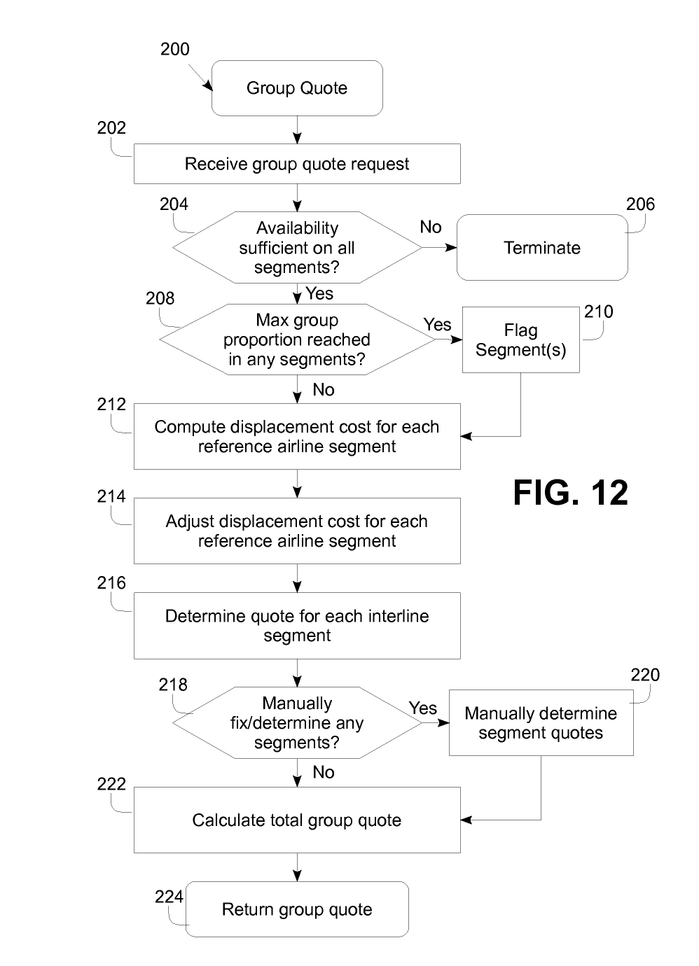

An exemplary group quote process 200 capable of being implemented in group quote module 38 is illustrated in FIG. 12, and begins in block 202 by receiving an appropriate group quote request. A typical group quote request may include parameters such as group size, trip type (e.g., one-way, return, open-jaw, circle trip, etc.), a list of requested segments (including those from the requested airline and potentially those from other airlines), and request originator data (e.g., details of the travel agency, sales office, partner airline, etc., from which the request originates. For each segment in the list of segments, segment parameters such as carrier, flight designator, departure date, board and/or off points, cabin, etc. may be provided with the request.

Next, in block 204 availability checks are performed to determine, for each listed reference airline segment, whether sufficient availability exists in the requested cabin. Notably, with group quote functionality implemented within an inventory system, real-time accurate availability counters may be accessed to ensure that the group quote may be based on up-to-date inventory data. If insufficient availability exists on any segment, block 204 passes control to block 206 to terminate the routine. Otherwise, control passes to block 208 to determine whether a maximum group proportion has been reached in any segments.

In particular, in some embodiments a maximum group proportion may be defined through a business rule, e.g., so that if the proportion of group bookings over the size of the cabin exceeds the applicable threshold, the process raises a warning. Thus, if the maximum group proportion is reached, control passes to block 210, where any such segments are flagged as exceeding the maximum group proportion. However, the process is typically permitted to continue so that a group quote will still be computed.

Therefore, if a determination is made in block 208 that the maximum group proportion is not reached in any segment, or after flagging segments in block 210, control passes to block 212 to compute a displacement cost for each reference airline segment. As discussed above in connection with the aforementioned revenue driven group travel request split operation, group requests are not only about filling empty inventory on a flight, as in most cases the inventory items taken by a group (or at least some of them) would have been taken by individual passengers, each one bringing a different revenue to the airline. In order to determine if a group request is profitable, the revenue brought by the group may be compared to the theoretical revenue brought by these displaced individual passengers, which is reflected herein by the concept of displacement cost.

The displacement cost for group quote operations may be determined in a number of manners consistent with the invention. For example, the displacement cost may be determined dynamically based upon current inventory and revenue data, e.g., in the various manners discussed above in connection with group travel request split operations based on bid price and/or yield values. The invention, however is not limited to these particular variations.

After the displacement cost is calculated for each reference airline segment, control then passes to block 214 to adjust the displacement cost for each reference airline segment to take into account additional factors such as the specificities of the requesting group or originator, or of the other segments of the trip. Adjustment factors to apply to displacement costs may be similar in many respect to the adjustment factors used above in connection with revenue driven group travel request split operations. For example, a set of business rules may be defined to enable the displacement cost to be adjusted by applying proportional or absolute modifiers or setting a minimum quote for each segment or over several segments.

These business rules may be defined according various criteria, including, for example, market origin of a segment, market destination of a segment, departure date of a segment, day of the week of a segment's departure date, operating airline of a segment, flight number, requested cabin, expected final load factor of a segment-cabin, size of the group, point of sale of the requestor, historical and forecast materialization rate of the requestor, type of trip (e.g., one-way, return, open-jaw, circle trip, etc.), origin and destination of the full trip, other airline segments of the trip, etc.

For each segment, modifiers may be applied first to the displacement cost, with any minimums applied thereafter, so that a minimum segment quote may be applied regardless of the effect of any modifier. Table VII below, for example, illustrates an example segment quote adjustment for a hypothetical segment, flight number 8X5, HEL-JFK, 15^{th} August:

TABLE VII

| | |
|---|---|
| Displacement cost | 500 [symbol] |
| Modifier due to low expected load factor: −10% | −50 [symbol] |
| Modifier due to one-way trip: +15% | +75 [symbol] |
| Internet travel agency: +10 [symbol] | +10 [symbol] |
| Connecting to a 7X segment: +5% | +25 [symbol] |
| Applicable minimum group quote: 510 [symbol] | 510 < 560 |
| Adjusted segment quote | 560 [symbol] |

Next, in block 216, segment quotes are generated for non-reference airline segments such as interline segments. Interline agreements enable an airline A to book groups on some segments operated by another airline B in connection to a segment operated or marketed by A. These agreements, dedicated to groups, are typically specific for some routes and not made public. When an interline agreement exists between two airlines, the validating carrier—i.e., the carrier towards which the ticket has been issued—collects the entire fare from the customer and is responsible for distributing the proceeds to other carriers' parts of the itinerary.

In order to automate the group quotation process to include other airline flights, it is typically desirable for revenue managers to generate two types of business rules to allow the system to implement the content of an interlining agreement.

The first type of business rule that may be used maps cabins of the other airline into the cabins of the reference airline, which enables the system to find an equivalent of the other airline cabin in the reference airline cabin in order to perform the group quotation process. This type of rule may be based upon input parameters or criteria such as connecting airline code, market origin (e.g., airport code, city or country), market destination (e.g., airport code, city or country), flight numbers impacted by the mapping, applicable dates, etc. The output of the rule typically needs to provide a consistent mapping between reference airline cabins and other airline cabins. For example, Tables VIII and IX show an example rule for mapping between the cabins of a reference airline “8X” that has signed an interlining agreement with airline “7X”:

TABLE VIII
Rule Criteria

| | |
|---|---|
| Connecting airline code | 7X |
| Market Origin | NCE |
| Market Destination | PAR |
| Flight Group | 7X10-7X15 |
| Start Date | 15 Jun. 2011 |
| End Date | 15 Sep. 2011 |

TABLE IX

| 8X Cabin | 7X Cabin |
|---|---|
| Y | M |
| C | C |
| M | F |

The second type of business rule that may be used sets add-on values specified in an interlining agreement. This type of rule may depend on criteria such as market origin (e.g., airport code, city or country), market destination (e.g., airport code, city or country), connecting airline, flight numbers of other airline impacted by the agreement, applicable dates, etc. The output of the rule then includes the values specified by the corresponding interlining agreement. Table X below, for example, illustrates an exemplary rule that defines the fare agreed with the connecting airline based upon the mapping defined in the example of Tables VIII-IX:

TABLE X

| Rule Criteria | |
|---|---|
| Market Origin | NCE |
| Market Destination | PAR |
| Connecting Airline | 7X |
| Flight Group | |
| Frequency | |
| Start Date | 15 Jun. 2011 |
| End Date | 15 Sep. 2011 |
| Rule Content | |
| Other Airline Cabin | M |
| Interline Group Quote Value | 60 [symbol] |

Next, control optionally passes to block 218 to determine whether to allow for any manual operations to fix and/or determine quotes for any particular flight segments. In some embodiments, for example, it may be desirable to allow the quotes of some segments to be fixed manually in order to bypass the automated computation or to include a segment for which no inventory data is available. In such instances, control passes to block 220 to allow for manual setting of quotes for one or more segments.

After manual setting is complete in block 220, or if no manual setting is required in block 218, control passes to block 222 to calculate a total group quote, and then to block 224 to return the group quote to the requesting entity. The total group quote in the illustrated embodiment, for example, is the sum of the group quotes of the segments of the trip, i.e., the adjusted displacement cost as defined in blocks 204, 208, 212 and 214 for reference airline segments, and the interline group segment quotes as defined in block 216 for other airline segments. In addition, in some embodiments one or more business rules may be applied to one or more of the segments (e.g., to apply a minimum rule such as segment A+segment B>=500 [symbol] ).

As an example, after having set the environment using the aforementioned example business rules, airline 8X may receive a group request for a group with a size of 10, an expected itinerary of Nice to New York for travel on 01JUL2011 in coach cabin Y. Assume, for example, that the system identifies a travel solution for the group including the following two flight segments:

7X010 NCE-CDG 01JUL2011

8X009 CDG-JFK 01JUL2011 (8X is operating the segment CDG JFK)

Based upon the desire to travel in coach cabin Y, routine 200 may utilize the example business rule in Tables VIII and IX to find the most suitable cabin for each segment of the request, thereby deducing the following flight segment details:

7X010 NCE-CDG 01JUL2011 Cabin M

8X009 CDG-JFK 01JUL2011 Cabin Y

After having calculated the group quote for the segment operated by airline 8X, which ends up to 450 [symbol] per passenger, airline 8X revenue management may automatically perform the quote computation for the other airline segment using the business rule defined above in Table X, and as a result the quote computed using the interlining agreement is 60 [symbol] , resulting in a total group quote of 510 [symbol] per passenger. In addition, this means that airline 8X will be paid 510 [symbol] and will give back 60 [symbol] to airline 7X for each passenger travelling into that group.

Therefore, through the use of a group quote module within an inventory system, group quote functionality may be implemented in a manner that utilizes up-to-date inventory and revenue data and accounts for the business needs of an airline or other travel provider.

It will be appreciated that the group quote functionality discussed herein may be, but is not required to be, used in connection with the aforementioned group travel request split operation to assist in generating quotes for the subgroups allocated to various candidate travel solutions. Furthermore, some of the features of the exemplary embodiments of this invention may be used without the corresponding use of other features. In addition, various additional modifications may be made without departing from the spirit and scope of the invention. Therefore, the invention lies in the claims hereinafter appended.

What is claimed is:

1. A computer-implemented method for processing a group travel request for air travel by a group between an origin and a destination, the method comprising:
receiving the group travel request from an originator, wherein the group travel request identifies the origin, the destination, a date criterion and a quantity for the group;
determining whether to perform a group split operation based upon the group travel request and a group split acceptance rule;
in response to determining to perform a group split operation, accessing at least one of a schedule system and an inventory system for the airline to identify a set of travel solutions matching the group travel request and having a group availability matching a minimum subgroup quantity criterion, including ranking each travel solution in the set of travel solutions based upon at least one of a group proportion selection rule associated with a proportion of an inventory of such travel solution allocated to groups, a materialization rate rule associated with a materialization rate of the originator of the group travel request, and an expected load factor rule associated with an expected load factor of such travel solution;
splitting the group travel request among a plurality of travel solutions in the set of travel solutions to allocate a subgroup quantity to each travel solution in the set of travel solutions, including:
accessing revenue data from a revenue system for the airline;
determining from the revenue data a unitary displacement cost for at least a portion of the inventory of each travel solution in the set of travel solutions, wherein the unitary displacement cost is associated with an opportunity cost for allocating an inventory item for a travel solution to the group travel request instead of allocating the inventory item to an individual booking;
adjusting the unitary displacement cost for the portion of the inventory of each travel solution using an adjustment factor based upon at least one adjustment rule to generate an adjusted displacement cost for the portion of the inventory of each travel solution; and
determining the subgroup quantity for each of the plurality of travel solutions based upon the adjusted displacement cost for the portion of the inventory of each travel solution to optimize an aggregated displacement cost among the plurality of travel solutions; and
responding to the group travel request by returning the subgroup quantity for each of the plurality of travel solutions;
wherein accessing the schedule system, the inventory system and the revenue management system minimizes database transactions.

2. A computer-implemented method for processing a group travel request for travel with a travel provider, comprising:
determining a set of travel solutions that match a group travel criterion for the group travel request and a travel provider criterion for the travel provider, wherein the group travel criterion includes a group quantity for the group travel request; and
splitting the group quantity into a plurality of subgroup quantities respectively allocated to travel solutions from the set of travel solutions to optimize expected revenue of the travel provider resulting from displacement of the group quantity from individual bookings.

3. The method of claim 2, wherein splitting the group quantity includes retrieving revenue data from a revenue management system and determining from the revenue data a displacement cost for at least a portion of the inventory of each travel solution in the set of travel solutions, wherein the displacement cost is associated with an opportunity cost for allocating an inventory item for a travel solution to the group travel request instead of allocating the inventory item to an individual booking.

4. The method of claim 3, wherein the revenue data includes yield data for each travel solution in the set of travel solutions, and wherein determining the displacement cost includes determining the displacement cost for at least one booking class in each travel solution in the set of travel solutions based upon the yield data.

5. The method of claim 4, wherein splitting the group quantity further includes allocating the group quantity to booking classes in the set of travel solutions in order of increasing displacement costs and based on group availability for the booking classes in the set of travel solutions, wherein the group availability is associated with a quantity of inventory items in a booking class that is available for group allocation.

6. The method of claim 4, wherein determining the displacement cost further includes:
determining from the yield data a unitary displacement cost for the at least one booking class in each travel solution in the set of travel solutions, wherein the unitary displacement cost is associated with an expected revenue for a sale of an inventory item in an associated booking class to an individual passenger; and
adjusting the unitary displacement cost for the at least one booking class in each travel solution using an adjustment factor to generate an adjusted displacement cost for the at least one booking class in each travel solution, wherein the adjustment factor is based on at least one factor selected from the group consisting of departure market, arrival market, start date, end date, expected load factor for a cabin associated with such travel solution, materialization rate of an originator of the group travel request, and a point of sale of the originator.

7. The method of claim 3, wherein the revenue data includes bid price data for a plurality of inventory items in each travel solution in the set of travel solutions, and wherein determining the displacement cost includes determining the displacement cost for each of the plurality of inventory items in each travel solution in the set of travel solutions based upon the bid price data.

8. The method of claim 7, wherein splitting the group quantity further includes allocating the group quantity to the subgroup quantities allocated to the travel solutions in the set of travel solutions in order of increasing displacement costs and based on group availability for each travel solution in the set of travel solutions, wherein the group availability is associated with a quantity of inventory items in a travel solution that is available for group allocation.

9. The method of claim 8, further comprising, in response to a subgroup quantity for a first travel solution in the set of travel solutions being less than a minimum subgroup quantity:
determining a first distribution cost for redistributing of the subgroup quantity for the first travel solution to other travel solutions in the set of travel solutions;
determining a second distribution cost for distributing additional group available inventory items from other travel solutions in the set of travel solutions to the first travel solution;
redistributing the subgroup quantity for the first travel solution to at least one other travel solution in the set of travel solutions if the first distribution cost is lower than the second distribution cost; and
distributing additional group available inventory items from at least one other travel solution in the set of travel solutions to the first travel solution if the second distribution cost is lower than the first distribution cost.

10. The method of claim 7, wherein determining the displacement cost further includes:
determining from the bid price data a unitary displacement cost for each of the plurality of inventory items in each travel solution in the set of travel solutions, wherein the unitary displacement cost is associated with a expected revenue for a sale of an associated inventory item to an individual passenger; and
adjusting the unitary displacement cost for each of the plurality of inventory items in each travel solution using an adjustment factor to generate an adjusted displacement cost for each of the plurality of inventory items in each travel solution, wherein the adjustment factor is based on at least one factor selected from the group consisting of departure market, arrival market, start date, end date, expected load factor for a cabin associated with such travel solution, materialization rate of an originator of the group travel request, and a point of sale of the originator.

11. The method of claim 2, wherein determining the set of travel solutions includes:
determining a plurality of travel solutions that match the group travel criterion; and
determining the set of travel solutions from the plurality of travel solutions based upon the travel provider criterion.

12. The method of claim 11, wherein the group travel criterion includes at least one group travel parameter selected from the group consisting of origin, destination, a date parameter, a schedule flexibility parameter, a route flexibility parameter, a minimum subgroup quantity and the group quantity.

13. The method of claim 11, wherein determining the set of travel solutions further includes discarding a travel solution having a group availability that is less than a minimum subgroup quantity associated with the group travel request.

14. The method of claim 11, wherein determining the set of travel solutions from the plurality of travel solutions includes:
accessing inventory data from an inventory system; and
applying at least one of a group proportion criterion, a materialization rate criterion, an expected load factor criterion and an acceptance criterion to discard at least one travel solution from the plurality of travel solutions.

15. The method of claim 14, wherein applying the at least one of the group proportion criterion, the materialization rate criterion, the expected load factor criterion and the acceptance criterion includes generating a composite ranking for each travel solution in the plurality of travel solutions based upon the group proportion criterion, the materialization rate criterion, the expected load factor criterion and the acceptance criterion.

16. The method of claim 2, further comprising determining whether to perform a group split operation for the group travel request based upon a group split acceptance criterion, wherein the group split acceptance criterion is based on at least one of a group travel parameter and a travel provider parameter.

17. The method of claim 16, manually intervening in response to a determination to not perform the group split operation in response to input received from a representative of the travel provider.

18. The method of claim 2, further comprising:
receiving the group travel request from an originator through a user interface; and
returning to the originator through the user interface a response comprising information data representative of the travel solutions to be used to accommodate the request, the subgroup quantity to be assigned to each such travel solution, and a quote amount for accommodating the request.

19. The method of claim 2, wherein determining the set of travel solutions and splitting the group quantity into the plurality of subgroup quantities are performed using a set of business rules defined by the travel provider.

20. An apparatus, comprising:
at least one processor; and
program code configured upon execution by the at least one processor to process a group travel request for travel with a travel provider by determining a set of travel solutions that match a group travel criterion for the group travel request and a travel provider criterion for the travel provider, wherein the group travel criterion includes a group quantity for the group travel request, and splitting the group quantity into a plurality of subgroup quantities respectively allocated to travel solutions from the set of travel solutions to optimize expected revenue of the travel provider resulting from displacement of the group quantity from individual bookings.

21. The apparatus of claim 20, wherein the program code is resident in a group split component, the apparatus further comprising:
an inventory system configured to provide real-time inventory data to the group split component;
a business rules system configured to manage a plurality of business rules, wherein the group split component is configured to determine the set of travel solutions and split the group quantity based upon at least one business rule managed by the business rules system;
a revenue management system configured to provide revenue data to the group split component;
a schedule system configured to provide candidate travel solutions to the group split component; and
a user interface configured to receive the group travel request from an originator and output the plurality of subgroup quantities to the originator.

22. The apparatus of claim 21, wherein the group split component is configured to minimize database transactions when accessing the schedule system, the inventory system and the revenue management system.

23. A program product, comprising:
a computer readable medium; and
program code stored on the computer readable medium and configured upon execution by at least one processor to process a group travel request for travel with a travel provider by determining a set of travel solutions that match a group travel criterion for the group travel request and a travel provider criterion for the travel provider, wherein the group travel criterion includes a group quantity for the group travel request, and splitting the group quantity into a plurality of subgroup quantities respectively allocated to travel solutions from the set of travel solutions to optimize expected revenue of the travel provider resulting from displacement of the group quantity from individual bookings.

24. A computer-implemented method for processing a group travel request for a reference travel provider, the method comprising:
receiving a group travel request that identifies a group quantity and at least one segment; and
using program code resident in an inventory system for the reference travel provider, determining a group quote for the group travel request based upon a displacement cost, wherein the displacement cost is based upon displacement of the group quantity from individual bookings.

25. The method of claim 24, wherein determining the group quote includes:
determining a group segment quote for each of a plurality of segments identified by the group travel request; and
determining the group quote by summing the group segment quotes.

26. The method of claim 25, wherein a first segment among the plurality of segments is a reference travel provider segment, and wherein determining the group segment quote for the first segment includes:
accessing current inventory data and revenue data associated with the first segment; and
determining a displacement cost for the first segment using the current inventory data and revenue data.

27. The method of claim 26, wherein determining the group segment quote for the first segment further includes adjusting the displacement cost by an adjustment factor.

28. The method of claim 27, wherein adjusting the displacement cost by the adjustment factor includes accessing a business rule.

29. The method of claim 27, wherein the adjustment factor is based upon at least one of market origin of the first segment, market destination of the first segment, departure date of the first segment, day of the week of the first segment's departure date, operating airline of the first segment, flight number, requested cabin, expected final load factor of the first segment, expected final load factor of a cabin of the first segment, the group quantity, point of sale of a requestor of the group travel request, historical and forecast materialization rate of the requestor, type of trip, origin and destination of a full trip, and at least one other segment among the plurality of segments.

30. The method of claim 29, wherein the adjustment factor is selected from the group consisting of an absolute modifier, a proportional modifier, and a minimum quote.

31. The method of claim 25, wherein determining the group segment quote for a first segment among the plurality of segments is based upon an interline agreement between the reference travel provider and another travel provider.

32. The method of claim 31, wherein determining the group segment quote for the first segment includes accessing at least one business rule to map a cabin for the other travel provider to a cabin for the reference travel provider, wherein the business rule is based upon at least one of a connecting airline code, a market origin, a market destination, a flight number and a date.

33. The method of claim 31, wherein determining the group segment quote for the first segment includes accessing at least one business rule to define a fare agreed between the reference travel provider and the other travel provider, wherein the business rule is based upon at least one of a connecting airline, a market origin, a market destination, a flight number and a date.

34. The method of claim 25, wherein the plurality of segments includes a first, reference travel provider segment and a second segment associated with another travel provider, wherein determining the group segment quote for the first segment includes determining a displacement cost for the first segment based upon current inventory data and revenue data for the reference travel provider, and wherein determining the group segment quote for the second segment is based on an interline agreement between the reference travel provider and the other travel provider.

35. The method of claim 34, wherein determining the group segment quotes for the first and second segments are performed using a set of business rules defined by the travel provider.

36. The method of claim 25, further comprising performing an availability check for each reference travel provider segment among the plurality of segments based upon current inventory data in the inventory system.

37. The method of claim 24, wherein determining the group quote for the group travel request includes determining the displacement cost based upon current inventory data stored in the inventory system and upon revenue data maintained in the inventory system and retrieved by the inventory system from a revenue system.

38. An apparatus, comprising:
at least one processor; and
program code configured upon execution by the at least one processor to process a group travel request for a reference travel provider, wherein the program code is resident in an inventory system and is configured to determine a group quote for a group travel request based upon a displacement cost, wherein the group travel request identifies a group quantity and at least one segment, and wherein the displacement cost is based upon displacement of the group quantity from individual bookings.

39. The apparatus of claim 38, wherein the program code is configured to determine the group quote by determining a group segment quote for each of a plurality of segments identified by the group travel request, and determining the group quote by summing the group segment quotes.

40. The apparatus of claim 39, wherein a first segment among the plurality of segments is a reference travel provider segment, and wherein the program code is configured to determine the group segment quote for the first segment by accessing current inventory data and revenue data associated with the first segment and determining a displacement cost for the first segment using the current inventory data and revenue data.

41. The apparatus of claim 40, wherein the program code is configured to determine the group segment quote for the first segment further by adjusting the displacement cost by an adjustment factor, wherein the adjustment factor is based upon at least one of market origin of the first segment, market destination of the first segment, departure date of the first segment, day of the week of the first segment's departure date, operating airline of the first segment, flight number, requested cabin, expected final load factor of the first segment, expected final load factor of a cabin of the first segment, the group quantity, point of sale of a requestor of the group travel request, historical and forecast materialization rate of the requestor, type of trip, origin and destination of a full trip, and at least one other segment among the plurality of segments, and wherein the adjustment factor is selected from the group consisting of an absolute modifier, a proportional modifier, and a minimum quote.

42. The apparatus of claim 39, wherein the program code is configured to determine the group segment quote for a first segment among the plurality of segments based upon an interline agreement between the reference travel provider and another travel provider.

43. A program product, comprising:
a computer readable medium; and
program code stored on the computer readable medium and configured upon execution by at least one processor to process a group travel request for a reference travel provider, wherein the program code is resident in an inventory system and is configured to determine a group quote for a group travel request based upon a displacement cost, wherein the group travel request identifies a group quantity and at least one segment, and wherein the displacement cost is based upon displacement of the group quantity from individual bookings.
